(19) United States
(12) Patent Application Publication
(10) Pub. No.: US 2008/0303749 A1
(43) Pub. Date: Dec. 11, 2008

(54) Active Matrix Array Device

(75) Inventors: Michael Cassidy, Reigate (GB); Steven Charles Deane, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,932

(22) PCT Filed: Nov. 13, 2006
(86) PCT No.: PCT/IB2006/054207

§ 371 Date: Jun. 11, 2008

(30) Foreign Application Priority Data
Dec. 13, 2005 (EP) 05112063.2

(51) Int. Cl. G09G 3/20

(52) U.S. Cl. 345/55

(57) ABSTRACT

An active matrix array device includes integrated driver circuitry which comprises a multiplexer circuit (2). The multiplexer circuit comprises an array of multiplexer elements (50), each comprising a multiplexer transistor (30), between a multiplexer input (Vdata) and a multiplexer output (32), and a threshold voltage storage capacitor arrangement (44) for storing a threshold voltage of the multiplexer transistor (30). The threshold storage capacitor arrangement comprises a capacitor in series between a control input (Vselect) for receiving a control signal for controlling the multiplexer transistor (30) and the gate of the multiplexer transistor (30). A switch arrangement (40,42) is used to sampling and store the threshold voltage of the multiplexer transistor on the threshold voltage storage capacitor arrangement.

This invention relates to active matrix array devices, and in particular to active matrix devices in which elements of the array are arranged into rows and columns, with multiplexer circuits used to reduce the number of connections which column driver/reading circuits must make to the array. For example, the invention relates to display devices.

The column driver circuit for an active matrix display device typically comprises an array of digital to analogue converters. A single resistor string is typically used to supply a large number of converter circuits, as this ensures good uniformity of the output voltages of the converters. The resistor string comprises a resistor or a set of resistors connected in series with connections being made at various points along the length of the string. A voltage is applied to each end of the resistor string, and in addition voltages may also be applied to intermediate points along the string. The outputs are taken from various points along the length of the string and the voltages present at these points represent the analogue output voltage levels of the digital to analogue converters.

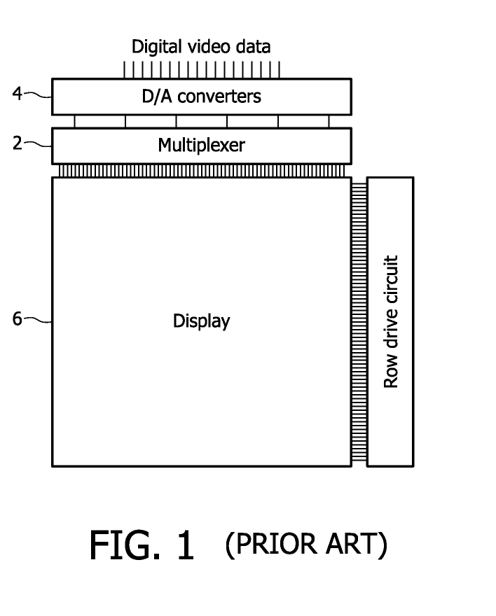

It is known to apply the output signals from the digital to analogue converters to a multiplexer circuit as illustrated in FIG. 1.

The multiplexer circuit 2 allows the output of each individual D/A converter of the converter circuit 4 to be selectively connected to one of a number of columns in the display 6. The use of a multiplexer circuit 2 simplifies the circuitry, since it is no longer necessary to provide latches for the digital data and a digital to analogue converter for each column in the display. A potential disadvantage of the multiplexed approach is that since each converter circuit supplies the signals for more than one column they must be operated at a higher speed with shorter conversion times.

It has been proposed to integrate the digital to analogue converters and the resistor string or strings onto the substrate of the display using thin film circuitry. The possibility of integrating the multiplexer circuits onto the glass substrate has also been proposed. This integration allows cost reduction by removing the requirement for external driver ICs. There is also the possibility to reduce the area of glass ledge that surrounds the viewable area if the circuits and the associated interconnect consume less space than the equivalent IC that they replace.

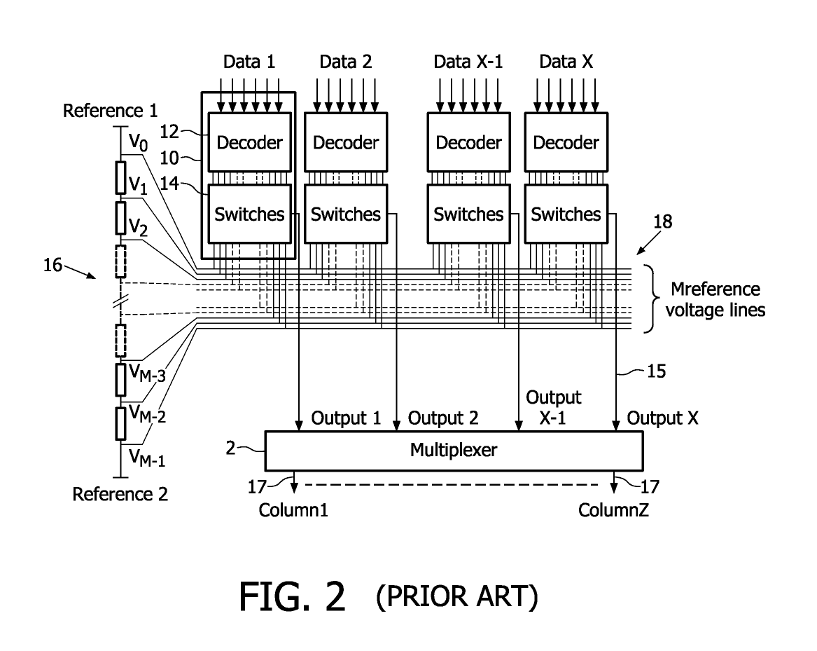

A possible circuit arrangement consisting of a number X of converters is shown in FIG. 2. Each digital to analogue converter 10 consists of a decoder 12 and a set of voltage selection switches 14. A resistor string 16 is used to generate the required number, M, of analogue reference voltages. Number M is related to the number of bits N in the digital input (“Data1”-“DataX”) by the equation M=2^{N}. The reference voltages are supplied to the digital to analogue converter circuits using a reference voltage bus 18 consisting of M lines.

The X converter outputs 15 are supplied to the multiplexer circuit 2 which routes the X outputs to a selected group of the Z columns 17 (where Z is equal to the number X multiplied by the multiplex ratio of the multiplexer 2).

This circuit arrangement has been proposed for integrated column drive circuits for low temperature poly-Si AMLCDs for a low number of bits of digital data (corresponding to a relatively low number of grey levels in the displayed images).

There is however, a particular interest in providing driver circuits which can be implemented using amorphous silicon technology. With amorphous silicon TFTs, it is widely known that the threshold voltage, Vt, drifts with time and temperature under positive gate bias. This means that traditional NMOS circuit designs will not be able to provide the same functionality over a given lifetime. By creating new circuits that take account of the threshold drift it is possible to provide functionalities on glass that have previously been considered impossible or at best have provided unsatisfactory lifetime/temperature performance.

The main problem to be expected when integrating circuits using amorphous silicon is a low circuit lifetime, as the circuits cannot tolerate the large amounts of threshold voltage drift.

According to the invention, there is provided an active matrix array device comprising an array of individually addressable matrix elements and address circuitry for addressing the matrix elements, wherein the address circuitry comprises a multiplexer circuit which is integrated onto the substrate of the matrix elements, wherein the multiplexer circuit comprises an array of multiplexer elements, each comprising:

a multiplexer transistor, between a multiplexer input and a multiplexer output;

a threshold voltage storage capacitor arrangement for storing a threshold voltage of the multiplexer transistor, the threshold storage capacitor arrangement comprising a capacitor in series between a control input (Vselect) for receiving a control signal for controlling the multiplexer transistor and the gate of the multiplexer transistor; and

a switch arrangement for sampling and storing the threshold voltage of the multiplexer transistor on the threshold voltage storage capacitor arrangement.

The circuit design takes account of the threshold drift of the multiplexer transistor, which may be amorphous silicon. This can be used to minimize the stressing of the transistor. By providing threshold voltage compensation, a long lifetime multiplexer/demultiplexer can be suitable for a very high resolution display, and provides long lifetime operation even after continuous stressing at high temperatures.

The switch arrangement can comprise a first measurement switch and a second measurement switch. This provides a relatively simple circuit.

In one example, the first measurement switch is connected between the gate and source of the multiplexer transistor, and the second measurement switch is connected between the source of the multiplexer transistor and a voltage power line, and wherein the threshold voltage storage capacitor arrangement comprises a coupling capacitor between the control input and a threshold capacitor between the gate and drain of the multiplexer transistor.

The coupling capacitor is used to effect a change in the control voltage applied. In this example, the multiplexer element is operable in two modes:

a first mode in which the multiplexer transistor is driven on and the multiplexer input is coupled to the output; and

a second mode in which the multiplexer transistor is driven on and the threshold voltage is stored on the second capacitor.

In an alternative implementation, the first measurement switch is connected between the control input and the source of the multiplexer transistor, and the second measurement switch is connected between the gate of the multiplexer transistor and a voltage supply line, and wherein the threshold voltage storage capacitor arrangement comprises a coupling capacitor between the control input (Vselect) and the gate of the multiplexer transistor.

In this design, the two measurement switches can be controlled by a shared control line. In this case, the multiplexer element is again operable in two modes:

a first mode in which the multiplexer transistor is driven on and the multiplexer input is coupled to the output; and

a second mode in which the multiplexer transistor is driven on and the threshold voltage is stored on the coupling capacitor.

The control signal for controlling the multiplexer transistor in the first mode can have an off value and an on value. All of the compensation is thus provided within the multiplexer element, and no changes to the control signal levels applied need to be made.

In a refinement, the control signal for controlling the multiplexer transistor in the first mode may have an off value and two possible on values, one for multiplexer input data in a first range and one for multiplexer input data in a second range. This is particularly suitable for polarity inversion schemes.

Each multiplexer element may then comprise a sub-element for multiplexing data in the first range and a sub-element for multiplexing data in the second range.

Preferably, the address circuitry further comprise a D/A converter array,

The device may be an active matrix liquid crystal display.

The invention also provides a multiplexer circuit for use in an address circuit for addressing matrix elements of an array, the multiplexer circuit for integration onto the substrate of the matrix element array and comprising an array of multiplexer elements, each comprising:

a multiplexer transistor, between a multiplexer input and a multiplexer output;

a threshold voltage storage capacitor arrangement for storing a threshold voltage of the multiplexer transistor, the threshold storage capacitor arrangement comprising a capacitor in series between a control input for receiving a control signal for controlling the multiplexer transistor and the gate of the multiplexer transistor; and

a switch arrangement for sampling and storing the threshold voltage of the multiplexer transistor on the threshold voltage storage capacitor arrangement.

The invention also provides a method of addressing an active matrix array device comprising an array of individually addressable matrix elements and address circuitry for addressing the matrix elements, the method comprising:

multiplexing between a first number of address signal lines and a second number of address lines of the array, using multiplexer elements of a multiplexer circuit, each multiplexer element comprising a multiplexer transistor; wherein the first number comprises a fraction of the second number, the multiplexing comprising:

during a calibration phase, sampling and storing a threshold voltage of the multiplexer transistor of each multiplexer element on a respective storage capacitor arrangement; and

during an address phase, addressing all elements of the array by switching on selected multiplexer transistors in turn to route multiplexer input data to an output of the multiplexer, wherein control signals provided for switching on the multiplexer transistors are altered by the storage capacitor arrangement in dependence on the stored threshold voltage.

This driving method has the capacity to provide lower power operation in the source driver IC, since the output voltage range can be switched at a lower duty cycle than a standard multiplexer design. This applies to a column or dot inversion scheme, which provides the best image quality for display applications.

The method is preferably for driving a display device, and the calibration phase is performed once per frame period, for example during a frame blanking period.

Examples of the invention will now be described in detail with reference to the accompanying drawings, in which:

FIG. 1 shows a known display configuration;

FIG. 2 shows a known arrangement for the D/A converters of FIG. 1;

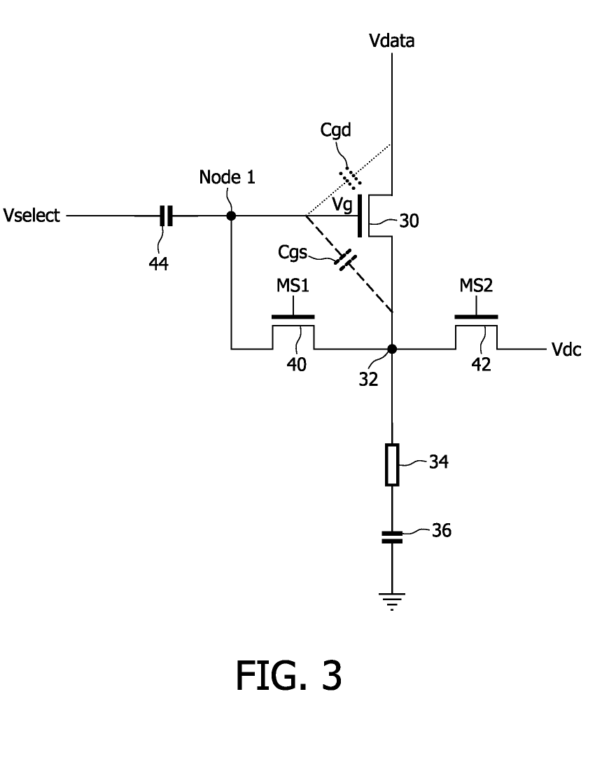

FIG. 3 shows a first example of multiplexer element of the invention;

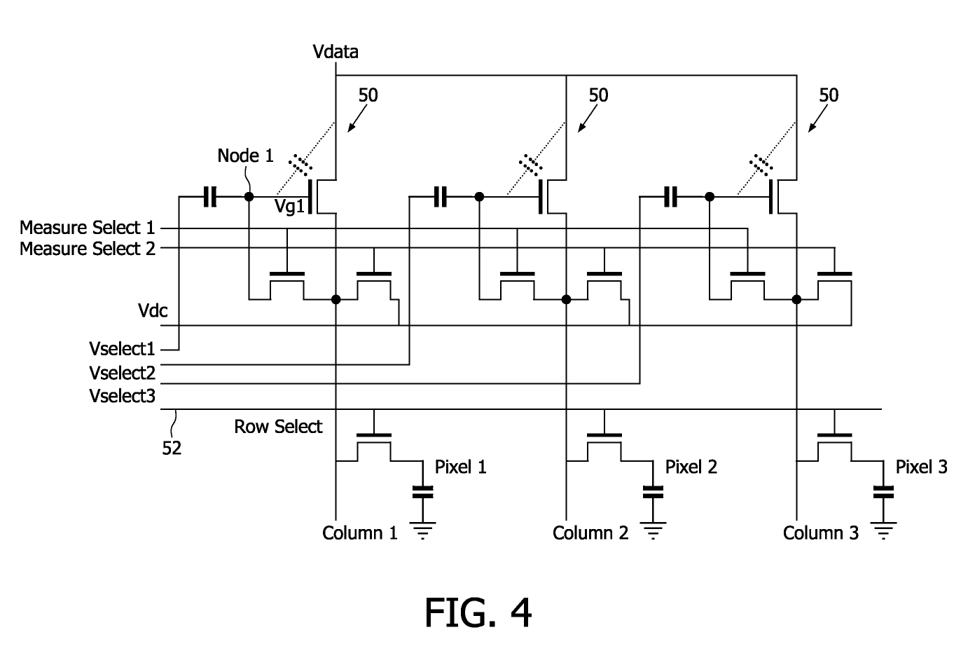

FIG. 4 shows a block of three multiplexer elements of FIG. 3 for a 3:1 multiplex ratio;

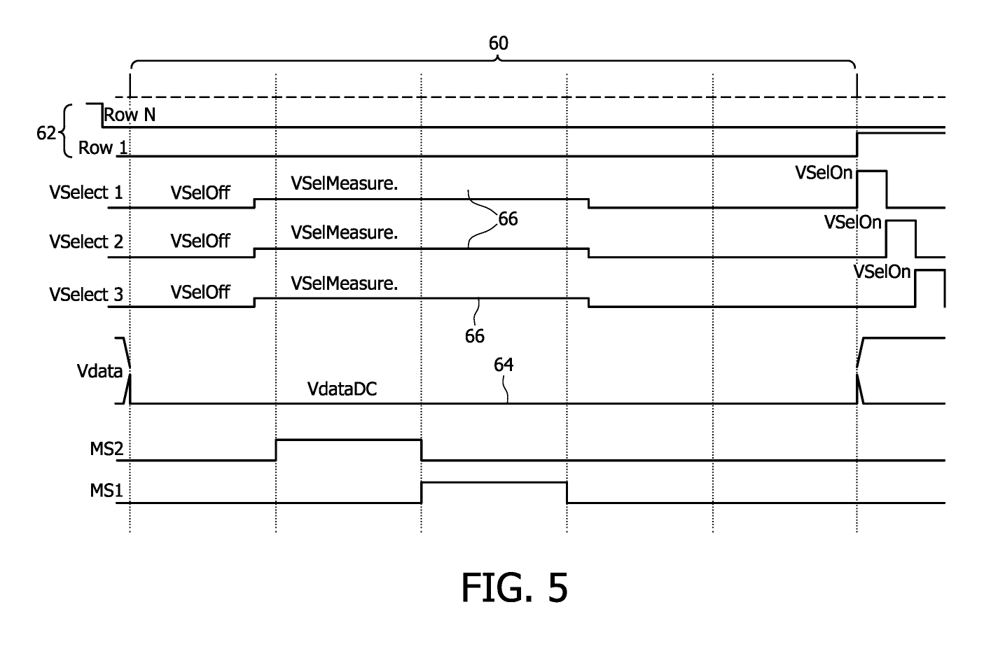

FIG. 5 shows a first timing diagram to explain the operation of the circuit of FIG. 4;

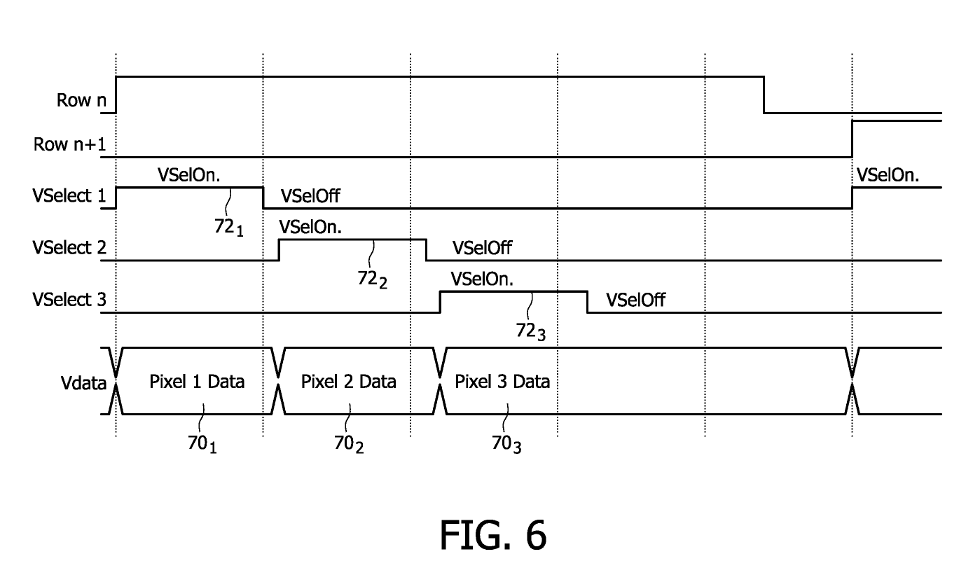

FIG. 6 shows a second timing diagram to explain the operation of the circuit of FIG. 4;

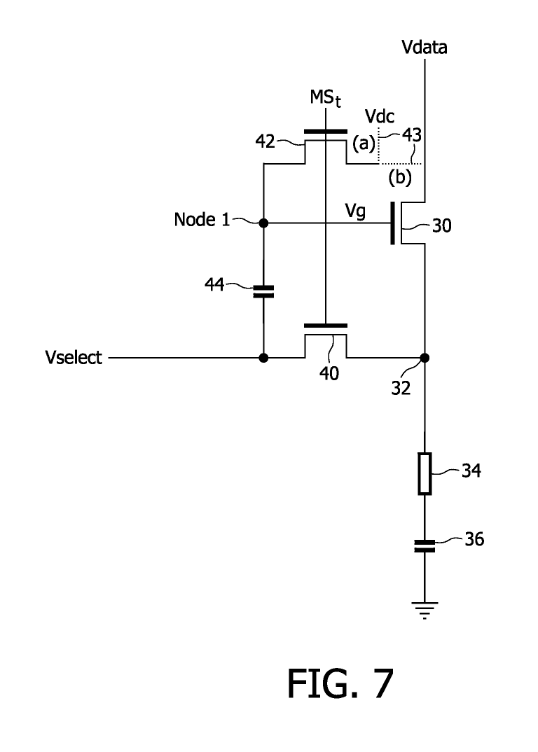

FIG. 7 shows a second example of multiplexer element of the invention; and

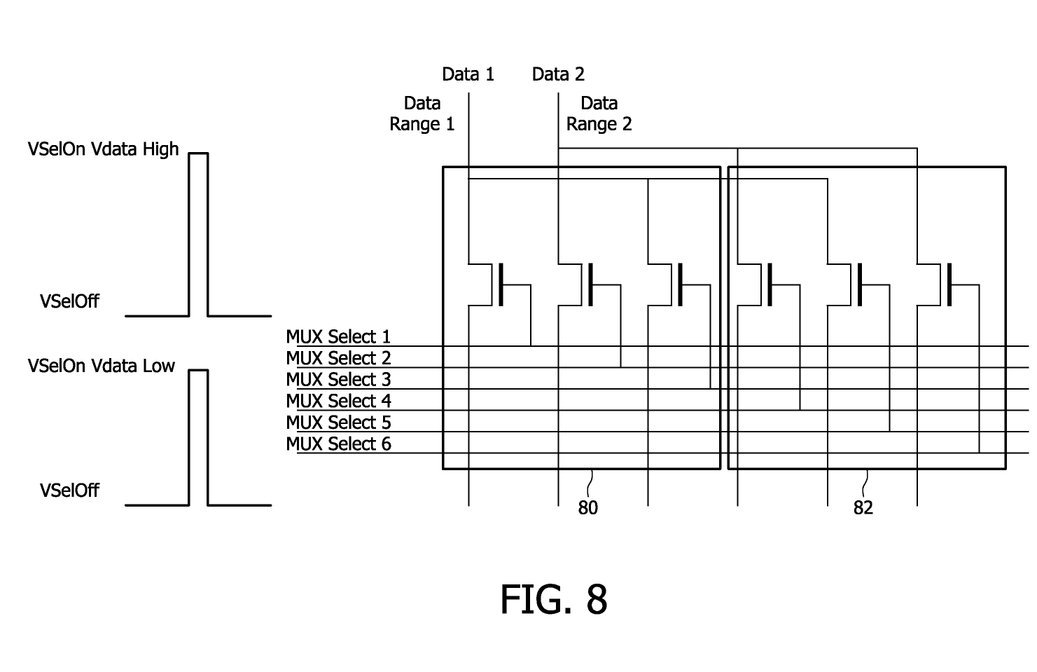

FIG. 8 shows a third example of multiplexer block of the invention.

The invention provides a multiplexer circuit comprising an array of multiplexer elements, which each comprise a threshold voltage storage capacitor arrangement for storing a threshold voltage of the multiplexer transistor. A switch arrangement enables sampling and storing of the threshold voltage of the multiplexer transistor on the threshold voltage storage capacitor arrangement. This is then used to provide correction of the control signal used for switching the multiplexer transistor.

It is known that the threshold voltage drift has a strong dependence on the duty ratio of a TFT, and one factor which makes amorphous silicon active matrix devices practical is that the duty ratio of a pixel TFT is very low (typically one line time per frame-time).

By performing a threshold voltage sampling operation once per frame-time, the gate voltage of the multiplexer transistor can be controlled to provide a long-lifetime operation despite the much higher duty ratio. The switch arrangement transistors used for the sampling operation can experience a much lower threshold drift due to their low duty factor and will therefore operate correctly over the lifetime of the display.

The multiplexer transistor can be operated at the minimum gate bias necessary to adequately charge the column to the data voltage, and this can be used to extend the lifetime further, since the threshold voltage drift is related to the difference between the gate bias and the threshold voltage. The threshold voltage sampling makes it possible to provide a gate bias that is at the minimum required level, while using constant input voltage levels, despite the threshold voltage drift with time.

The principal of operation of the circuit can be explained using simplified equations. The initial gate bias required at time t=0 (time t0) to create minimum aging of the multiplexer TFT whilst providing full charging of the column within the specified multiplexed time division is denoted Vg0.

If the threshold voltage at time t0 is denoted Vt0, and the threshold at any subsequent time t is given by Vt, the threshold voltage change can be written as:

dV=Vt−Vt0

The circuit of the invention is then arranged to apply a gate bias at time t which is given by Vg, where:

Vg=Vg0+dVt

Thus, the gate voltage for switching the multiplexer transistor factors in the change in threshold voltage over time.

The maximum gate voltage is limited by the voltage supply used during the threshold measurement operation. In practice, due to parasitic effects, the measured threshold voltage will be slightly different to the actual threshold voltage, and the initial control voltage value (Vg0) is chosen to accommodate this error to provide a suitable lifetime.

The threshold sampling can be arranged to be modified as a function of the operating temperature. This can be used to minimize the aging of the multiplexer transistor, thereby providing longer lifetime operation and also by providing additional gate bias at low temperatures to enable a wide-operating temperature range.

A number of circuits are possible to provide the operation outlined above, and two main embodiments are described below.

A first embodiment of circuit of the invention is shown in FIG. 3, which shows one of an array of multiplexer elements of a multiplexer circuit. The multiplexer element comprises a multiplexer transistor switch 30, between a multiplexer input, in the form of a column data signal Vdata, and a multiplexer output 32 in the form of a column of the array of pixels. This column of pixels is represented by a column resistance 34 and a column capacitance 36.

The switch 30 comprises an n-type amorphous silicon transistor. A parasitic gate-drain capacitance Cgd and a parasitic gate-source capacitance Cgs are shown, and these have an influence on the threshold voltage sampling as explained below. An additional capacitor may also be added to the circuit. The control line used to control the multiplexer transistor is applied to the gate of the transistor 30 through a coupling capacitor 44.

The capacitors Cgd and Cgs, in combination with the coupling capacitor 44, act as a threshold voltage storage capacitor arrangement for storing a threshold voltage of the multiplexer transistor 30. The capacitor 44 dominates the capacitive circuit. The coupling capacitor 44 is used to effect a bootstrap change in the voltage applied to the input Vselect.

A switch arrangement is provided for sampling and storing the threshold voltage of the multiplexer transistor 30 on the threshold voltage storage capacitor arrangement.

In the example of FIG. 3, this switch arrangement comprises a first measurement transistor 40 controlled by a first measurement select line MS1 and a second measurement transistor 42 controlled by a second measurement select line MS2. The first measurement transistor is connected between the gate and source of the transistor 30 and the second measurement transistor 42 is connected between the source of the transistor 30 and a dc supply line (Vdc).

Three of the multiplexer elements shown in FIG. 3 form a 3:1 de-multiplexer block as illustrated in FIG. 4.

As shown in FIG. 4, each multiplexer element 50 is associated with an individual column (column 1, column 2, column 3), and one pixel is represented in each column, together with a single row address line 52. Each multiplexer element has its own select line Vselect1, Vselect2, Vselect3. It will be apparent to those skilled in the art that each block of three multiplexer elements can share the three select lines. As also shown, the measurement select lines MS1, MS2 are common to all three multiplexer elements, and again these may be common to all multiplexer blocks.

The block of multiplexer elements is coupled to a single data input Vdata, and the operation of the block is to route a Vdata signal to each column in turn, so that the number of data connections to the column driver circuit is reduced by a factor of three (in this example).

The operation of the circuit of FIGS. 3 and 4 has two distinct phases; normal operation and threshold sampling.

The normal operation is the period during which the circuit acts to demultiplex data from the single data line input Vdata to the three separate columns of the active matrix array. This multi-phase demultiplex operation will occur once per line-time.

Threshold sampling occurs once per frame-time. In this phase of operation, the threshold of the multiplexer transistor 30 for each multiplexer element is sampled and stored.

The operation is described with reference to FIGS. 5 and 6, which demonstrate illustrative timings.

FIG. 5 is used to show the threshold measurement operation, which is carried out during the frame blanking period, between the addressing of the last row, RowN, and the first row, Row1.

During the frame blanking period, the row address lines 62 are all low.

The threshold measurement is carried out using the following steps:

1) All data outputs Vdata of the source IC (the column driver circuit) are brought low to a fixed DC level 64. Instead of controlling the column driver outputs in this way, the outputs can be made high impedance, and a DC source can then be connected to the data lines by means of an additional TFT switch (not shown).

2) The Vselect voltages which are for controlling the multiplexer transistors 30 are brought, from a low level (Vseloff) which maintains the transistors 30 off, up to a DC level 66 that is approximately equal to:

VSelMeasure=|Voff|*(Cpar+C₄₄)/C₄₄

where:

VSelMeasure is the select voltage applied during the threshold voltage measurement phase;

Voff is the voltage below Vt required to keep the leakage current in the off-state within the specified error limits dependent on the minimum data resolution and perceptibility; and

(Cpar+C₄₄)/C₄₄ denotes the voltage divider that exists between the coupling capacitance 44 and all parasitic capacitances such as Cgs and Cgd in the circuit that prevent the full voltage change in Vselect being observed at the gate node, Node 1.

Thus, the voltage on the select line is designed to give rise to a change in the gate voltage of Voff, namely to bring the operating point of the transistor 30 close to the threshold voltage. The TFT is returned to substantially the same state that it was in at the end of the last threshold measurement phase, and this is near to threshold. The transistor 30 is still off at this time. This enables threshold voltage sampling to be implemented.

3) A pulse is applied to MS2 to turn the transistor 42 on and charge the column via transistor 42 to approximately Vdc. This does not need to be accurate, but the column must be above the threshold voltage.

4) Transistor 42 is turned off, and transistor 40 is turned on by applying a pulse to MS1. The charge stored on the column is then shared between the column and Node 1. This charge sharing could also be avoided if MS2 is left on until after MS1 has switched on, and this can enable slightly higher threshold voltages to be measured. The column capacitance may be significantly higher than the node capacitance, although this is not necessary.

MS1 and MS2 may be made common. This would still allow a voltage closely related to the threshold voltage of the transistor 30 to be stored, as it is much larger that the transistor 42. This mode of operation would not achieve the temperature compensation benefits but provides simplification.

Turning on transistor 40 tends to increase the voltage at Node 1, thereby raising the gate voltage of the transistor 30 and gradually turning it on.

When the gate voltage of the multiplexer transistor 30 reaches the threshold voltage of the transistor 30, the transistor 30 will start to turn on, but draining current to the low voltage Vdata, thereby discharging the column capacitance 36 and the node Node1 until the gate voltage is equal to the column voltage which is approximately equal to:

Vdata+Vt.

The transistor discharges the capacitances to the low dc voltage on the data line Vdata. The threshold voltage Vt of the input side of the multiplexer transistor is stored on the capacitance arrangement, of which the capacitor 44 is dominant.

5) MS1 is then brought low to isolate the threshold measurement and, Vselect is brought back down to an off voltage VSelOff.

This change in voltage (of VSelMeasure) again translates through capacitive coupling to a change in the voltage on the gate of Voff. Thus, this brings the gate voltage to approximately Voff below the threshold voltage. This state of the circuit, with the gate voltage at a level Voff below the threshold voltage, was the approximate starting point, with cycle having recalibrated for a new sampled threshold voltage. The select line is at VSelOff, and the change in the gate voltage to implement the threshold compensation thus provides a change in the voltage across capacitor 44, which therefore essentially stores the threshold voltage by adapting its voltage to reflect changes in the threshold voltage.

FIG. 5 shows the select voltage VSelOn subsequently applied to the multiplexer elements in turn for each row address signal.

The select voltage thus has three levels. One is a low voltage (VSelOff) to switch off the multiplexer transistor 30, one is an intermediate voltage (VSelMeasure) to bring the switch 30 close to threshold for a threshold sampling operation, and one is to turn the switch fully (VSelOn) on for a multiplexing operation.

In normal operation, the threshold measurement will be stored on the capacitor arrangement. The normal operation is shown in FIG. 6, for one row, Row n.

It can be seen that the sampling operation provides a voltage on the gate (at Node1) which takes account of the threshold voltage.

During the row address pulse, the normal operation proceeds as follows.

1) The row select signal goes high (Row n).

2) Vdata for the first column will be presented by the source IC (the column driver circuit). This is shown as “Pixel1Data” 70₁, and the pixel data to be switched by the second and third elements are shown as 70₂ and 70₃.

3) VSelect1 goes high to VSelOn as shown at 72₁, where VSelOn is related to the minimum voltage over threshold required to charge the column to the desired voltage Vdata within acceptable errors within the column select time.

4) The gate voltage of the first multiplexer transistor will be boosted to a voltage approximately equal to:

Vghigh=VSelOn+dVt.

The voltages are selected so that the gate receives the desired voltages after the capacitive division.

This voltage boosting provides compensation for threshold voltage variations, although in practice it will be appreciated that there will be some losses due to the parasitic capacitances in the circuit.

5) Column1 is then charged to Vdata through the multiplexer transistor 30.

6) VSelect1 is brought low to VSelOff. Due to the gate-source capacitance of the multiplexer transistor 30, the column voltage will be ‘kicked’ down slightly, but by an amount independent of the threshold voltage drift. This voltage error will be dependent on data and can therefore be corrected for by gamma and/or common electrode adjustment or any other such means, as will be apparent to those skilled in the art.

7) The data value is changed to Vdata for the second column and steps 2-5 are repeated for each multiplexed column in the block. Thus, in the example shown, there are three Vselect pulses for each multiplexer block, 72₁, 72₂, 72₃.

8) The final column of each grouping will experience a voltage change when its multiplexer transistor is turned off and charge sharing occurs via the parasitic capacitances of the multiplexer transistor. A final division of the row select time is allocated to allow this error voltage to be transferred to the pixel, dependent on the RC time constant of the column and pixel TFT. This additional time period thus compensates for the fact that the last column to be addressed has a shorter time after the select pulse goes low for any charge redistribution to settle. By providing sufficient time for the last column to settle, the response for all columns is made equal.

9) The row select signal goes low.

This approach provides kickback that is substantially independent of the threshold voltage.

FIG. 6 omits the phase with the output Vdata driven to a constant value for the measurement phase.

In a second embodiment of the circuit shown in FIG. 7, the number of control lines is reduced.

The principle is the same as described previously, in that a threshold voltage measurement is taken once per frame-time and stored for the remainder of the frame. The stored threshold voltage is added to the multiplexer select voltage during normal operation to provide sufficient gate bias to charge the column but minimize the aging of the high duty-factor multiplexer TFT.

The same reference numerals have been used for the same components as in FIG. 3.

There are again two measurement select transistors 40,42, but these are arranged differently, to enable control using a shared control line. The first measurement select transistor 40 is connected between the control input Vselect to the multiplexer element and the source 32 of the multiplexer transistor 30, and the coupling transistor 44 is connected between the input and the gate of the transistor 30 (i.e. Node1). The second measurement select transistor 42 is connected between the gate and drain of the transistor 30 or between the gate and another dc voltage line. The two possible connections for the transistor 42 are shown in FIG. 7 as (a) and (b) generally at reference 43.

There will still be a parasitic Cdg and Cgs in FIG. 7, so there will also be a predictable charge sharing effect which can be compensated by appropriate selection of the control voltages.

In the measurement phase during frame blanking, a threshold measurement is obtained by following the following steps:

1) All columns are driven to a low voltage, for example by setting Vdata low and pulsing all the multiplexer gates (in sequence or simultaneously). This provides a reset operation

2) All data outputs of the source IC are brought to a high fixed DC level (for example the maximum output of the source IC for maximum threshold voltage measurement capacity)

3) The Vselect line is placed into a high impedance state

4) A pulse is applied to the single Measure Select line MS to turn both measurement transistors 40,42 on.

The gate node, Node1, will be charged to either the dc voltage or to the data voltage Vdata, depending on the connection configuration ((a) or (b) in FIG. 7).

5) As the gate voltage rises above Vt of the multiplexer transistor, this transistor will turn on and the source (node 32) will start to rise until it is the threshold voltage Vt below the gate voltage. The gate source voltage Vgs=Vt will then be stored across the capacitor 44.

In practice, since the select line Vselect is connected to many multiplexer blocks, the stored threshold voltage will tend towards the average, which should be adequate in most cases. Also, as the source voltage begins to rise, the gate voltage will be bootstrapped up through the capacitor 44. At high temperature, the measurement transistor 42 can dissipate this extra charge to the DC line within the measurement period.

At low temperature this extra stored charge is beneficial to enable better column charging in normal operation.

6) The MS line is then brought low to isolate the threshold measurement and the select line Vselect is brought back down to VSelOff. This will bring the gate voltage to approximately the threshold voltage above VSelOff.

The threshold voltage is again stored on the capacitor 44, and this is added to the gate control voltage applied to the select input to provide threshold voltage compensation.

The operation of this circuit differs from the previous version in that the threshold voltage is measured at the output side of the multiplexer transistor.

In normal operation, the threshold measurement will be stored on the capacitor 44. As before, the normal operation has the following steps:

1) The row select signal goes high.

2) Data Vdata for the first column is presented by the source IC.

3) VSelect1 goes high to VSelOn, where VSelOn is equal to the minimum voltage over threshold required to charge the column to Vdata within error margins within the column select time.

4) The gate voltage will be boosted to a voltage Vghigh which is approximately equal to VSelOn+dVt.

In practice there will be some losses due to the parasitic capacitances in the circuit.

5) The column is charged to the required data voltage Vdata through the multiplexer transistor.

6) VSelect1 is brought low to VSelOff. Due to the gate source capacitance of the multiplexer transistor, the column voltage will be ‘kicked’ down slightly, but again since the voltage swing of the gate node from Vg to Vt will be approximately constant, the voltage error on the column will also be approximately constant and can be corrected.

7) The data value is changed to Vdata for the second column and steps 2-5 will be repeated for each multiplexed column in the grouping.

8) The final column of each grouping will again experience a voltage change when its multiplexer transistor is turned off and charge sharing occurs via the gate source capacitances of the multiplexer transistors. Again, a final division of the row select time is allocated to allow this error voltage to be transferred to the pixel, dependent on the RC time constant of the column and pixel TFT.

9) The row select signal goes low.

It can be seen that the normal phase proceeds in the same way as outlined above.

This approach again provides kickback which is independent of threshold voltage.

The duration of the measurement phases combined with the relative device sizes controls the errors to tune the temperature compensation.

This means that the gate bias of the multiplexer transistor is minimized when the acceleration of the threshold drift due to temperature is greatest. This time is also specified so that at low temperature, when a higher gate voltage is necessary to achieve correct column charging during the selection period, the charge removed within the measurement period will be less thereby creating a larger stored voltage on the sampling mechanism used.

The two implementations above can be extended to increase the lifetime even further by minimizing the gate bias in all conditions.

Specifically in the case of a liquid crystal display, because LC materials respond to the RMS voltage across them, and can show DC image sticking effects if the polarity is not reversed periodically, it is normal to have two data ranges about a central voltage where the voltage transmission curve is symmetrical.

Given the case of a unipolar source IC, which is common with many dot or column inversion drive schemes, the data appearing at the drain of the multiplexer transistor 30 will have one of two maximum values within a line-time per column. Since the minimum gate voltage required to charge the column within the specified time must be set relative to the data voltage, it is possible to set the voltage VSelOn at one of two values depending on the data range (hereafter named data ranges Data-High and Data-Low).

With two potential values for VSelOn of VselOnDataHigh and VselOnDataLow, the lifetime can be improved further, by ensuring:

VselOnDataHigh−VdataHigh=VselOnDataLow−VdataLow=Vmin=Vg−Vt

This concept can be extended to make interleaved multiplexers, for example to provide a 6:2 multiplex ratio. This means that the power can be reduced by only switching the data range in the source driver once per line-time in the case of a dot or column inversion drive scheme. This is illustrated in FIG. 8, where the measurement switches are omitted for clarity.

As shown, two data inputs Data1, Data2 are provided for the different polarity inversion phases, giving different data ranges. A first multiplexer sub-element 80 is for one RGB column group and a second multiplexer sub-element 82 is for the next RGB column group.

In FIG. 8, columns 1, 3 and 5 are connected to Data 1 and columns 2, 4 and 6 are connected to Data 2. In a given line time, Data 1 may be high range and Data 2 low range, but in the next line time they can swap ranges. This avoids having to swap Data 1 and Data 2 between high and low ranges within a line time, which consumes power. In addition, all of the high data range signals can be on one group of multiplexer lines (for example 1, 3 and 5) and the low range signals can be on the other group, so that the voltages are used more efficiently, without excessive voltages used for either range.

A further modification is to remove the voltage error on the columns due to charge-feedthrough via the series connection of gate-source and gate-drain capacitances of the multiplexer transistor 30. When a column is deselected, the data voltage at its drain will be varying with the data applied to the other columns in that de-multiplexer grouping. Assuming that any voltage error on the columns is only due to this capacitively coupled data voltage and not leakage in the multiplexer transistor 30, it is possible to eliminate the error by applying a compensating voltage of known value in the final portion of the row select time, when all columns are deselected.

The total coupling onto a column in the line-time will then be independent of the other data voltages applied and will only be dependent on its own data. Therefore, this error will be constant with data and can be corrected for by gamma adjustment or any other such means which will be known to those skilled in the art.

A further addition to the circuits described above, is to create the Measure Select Signal(s) (MS, MS1, MS2) from additional outputs of the Gate Scan Driver. Since there are usually additional outputs available, and these signals are only required once per frame-time in the frame blanking period, this can reduce the number of control signals required to operate the multiplexer, thereby reducing cost. This is particularly beneficial in the case where an integrated Gate Scan Driver is implemented and additional outputs can be made without additional circuitry.

With reference to FIG. 7, if connection (b) is used at 43, no extra external signal lines are then required to drive the threshold sampling circuit.

A further addition is that for column or dot inversion source ICs, which may not have the ability to drive all outputs within the same range concurrently, the correction is still performed by operating the threshold voltage measurement in two phases. This would require double the number of measure Select Signals.

Some driver circuits cannot provide high or low signals to all pins simultaneously as they share internal components between pins, and this can be resolved by making pins high impedance or by separating the correction phase into two cycles, one for odd pins and one for even pins. This gives the need for more control signals.

The specific example given above is a display device, in which the multiplexer circuit is for coupling column drive signals to the display array. However, the invention is applicable to other array devices. For example, the invention may be used for multiplexing column data from an array detector device such as an optical sensor/scanner to a shared data out line.

The example described refers to a 3:1 de-multiplexer ratio but the invention is of course applicable to other ratios.

The term “multiplexer” is intended to cover multiplexing and demultiplexing circuits and operations.

Many different TFT and capacitor arrangements are possible. One capacitor is required between the control input Vselect and the gate of the multiplexer transistor 30, so that a bootstrapping effect may be obtained to cause a change in the control voltage applied before it is applied to the gate. However, many other capacitor arrangements are possible, and only two examples have been given.

The invention can be applied to any type of TFT technology where there is threshold voltage drift, including organic semiconductor TFTs, and oxidic semiconductor TFTs.

The example above describes the multiplexing of analogue data. However, the invention can also be used when the multiplexer TFT is for routing digital data, for example as may be used for the drive of an electrophoretic display device.

From reading the present disclosure, other modifications will be apparent to persons skilled in the art. Such modifications may involve other features which are already known in the field of active matrix array devices and component parts thereof and which may be used instead of or in addition to features already described herein.

1. An active matrix array device comprising an array (6) of individually addressable matrix elements and address circuitry for addressing the matrix elements, wherein the address circuitry comprises a multiplexer circuit which is integrated onto the substrate of the matrix elements, wherein the multiplexer circuit comprises an array of multiplexer elements, each comprising:
a multiplexer transistor, between a multiplexer input and a multiplexer output;
a threshold voltage storage capacitor arrangement for storing a threshold voltage of the multiplexer transistor, the threshold storage capacitor arrangement comprising a capacitor in series between a control input for receiving a control signal for controlling the multiplexer transistor and the gate of the multiplexer transistor; and
a switch arrangement for sampling and storing the threshold voltage of the multiplexer transistor on the threshold voltage storage capacitor arrangement.

2. A device as claimed in claim 1, wherein the multiplexer transistor comprises an amorphous silicon n-type transistor.

3. A device as claimed in claim 1, wherein the switch arrangement comprises a first measurement switch and a second measurement switch.

4. A device as claimed in claim 3, wherein the first measurement switch is connected between the gate and source of the multiplexer transistor, and the second measurement switch is connected between the source of the multiplexer transistor and a voltage power line, and wherein the threshold voltage storage capacitor arrangement comprises a coupling capacitor between the control input and the gate of the multiplexer transistor.

5. A device as claimed in claim 4, wherein the multiplexer element is operable in two modes:
a first mode in which the multiplexer transistor is driven on, and the multiplexer input is coupled to the output at an output side of the multiplexer transistor; and
a second mode in which the multiplexer transistor is driven on and the threshold voltage at the input side of the multiplexer is stored on the coupling capacitor.

6. A device as claimed in claim 3, wherein the first measurement switch is connected between the control input and the source of the multiplexer transistor, and the second measurement switch is connected between the gate of the multiplexer transistor and a voltage supply line, and wherein the threshold voltage storage capacitor arrangement comprises a coupling capacitor between the control input and the gate of the multiplexer transistor.

7. A device as claimed in claim 6, wherein the voltage supply line comprises a dc voltage supply line or the multiplexer input.

8. A device as claimed in claim 6, wherein the multiplexer element is operable in two modes:
a first mode in which the multiplexer transistor is driven on and the multiplexer input is coupled to the output at an output side of the multiplexer transistor; and
a second mode in which the multiplexer transistor is driven on and the threshold voltage at the output side of the multiplexer transistor is stored on the coupling capacitor.

9. A device as claimed claim 1, wherein the multiplexer element is operable in a multiplexing mode and a threshold sampling mode, and in the multiplexing mode, the control signal for controlling the multiplexer transistor has an off value and an on value.

10. A device as claimed in claim 1, wherein the multiplexer element is operable in a multiplexing mode and a threshold sampling mode, and in the multiplexing mode the control signal for controlling the multiplexer transistor has an off value and two possible on values, one for multiplexer input data in a first range and one for multiplexer input data in a second range.

11. A device as claimed in claim 10, wherein each multiplexer element comprises a sub-element for multiplexing data in the first range and a sub-element for multiplexing data in the second range.

12. A device as claimed in claim 9, wherein the control signal has a threshold measurement level for use in the threshold sampling mode.

13. A device as claimed in claim 1, wherein the address circuitry further comprises a D/A converter array.

14. A device as claimed in claim 1, comprising an active matrix liquid crystal display.

15. (canceled)

16. A method of addressing an active matrix array device comprising an array of individually addressable matrix elements and address circuitry for addressing the matrix elements, the method comprising:
multiplexing between a first number of address signal lines and a second number of address lines of the array, using multiplexer elements of a multiplexer circuit, each multiplexer element comprising a multiplexer transistor; wherein the first number comprises a fraction of the second number, the multiplexing further comprising:
sampling and storing a threshold voltage of the multiplexer transistor of each multiplexer element on a respective storage capacitor arrangement; and
addressing all elements of the array by switching on selected multiplexer transistors in turn to route multiplexer input data to an output of the multiplexer, wherein control signals provided for switching on the multiplexer transistors are altered by the storage capacitor arrangement in dependence on the stored threshold voltage.

17. A method as claimed in claim 16, wherein a number of address signals are routed between a shared address signal line and multiple address lines.

18. (canceled)

19. (canceled)

20. A method as claimed in claim 16, wherein a calibration phase is performed once per frame period.

21. A method as claimed in claim 20, wherein a calibration phase is performed during a frame blanking period.

22. A method as claimed in claim 16, wherein an address phase includes either providing data to the elements of the array or reading data from the elements of the array.

23. A method as claimed in claim 16, wherein the multiplexer transistors are turned on with one voltage level for multiplexer input data in a first range and one for multiplexer input data in a second range.
